(19) United States
(12) Patent Application Publication
(10) Pub. No.: US 2024/0010801 A1
(43) Pub. Date: Jan. 11, 2024

(54) METHOD FOR PRODUCTION OF FLUOROPOLYMER MICROPOWDERS WITH REDUCED PFAS/PFOA

(71) Applicant: PPG Industries Ohio, Inc., Cleveland, OH (US)

(72) Inventors: James W. Downing, Jr., Mullica Hill, NJ (US); Kurt L. Mecray, Morgantown, PA (US); Michael J. Haley, West Chester, PA (US)

(73) Assignee: PPG Industries Ohio, Inc., Cleveland, OH (US)

(21) Appl. No.: 18/253,939

(22) PCT Filed: Nov. 24, 2021
(86) PCT No.: PCT/US2021/060863

§ 371 Date: May 23, 2023

Related U.S. Application Data
(60) Provisional application No. 63/118,179, filed on Nov. 25, 2020.

(51) Int. Cl. C08J 3/12; B29C 71/02; C08F 6/26; C08F 8/50

(52) U.S. Cl. CPC C08J 3/12; C08J 7/08; C08F 6/26; C08F 8/50; C08J 2327/18

(57) ABSTRACT

A method of manufacturing fluoropolymer micropowders with low perfluoroalkyl species (PFAS) content, such as perfluorooctanoic acid (PFOA). The method includes thermally treating, at a temperature from 125° C. to 300° C. Ma substantially oxygen free atmosphere and/or in a fluidized bed reactor, an irradiated or thermally degraded perfluorinated fluoropolymer. The method may also include micronizing the thermally treated low molecular weight fluoropolymer intermediate to provide a micropowder.

### CROSS REFERENCE TO RELATED APPLICATION

This application claims priority to U.S. Provisional Patent Application Ser. No. 63/118,179, filed on Nov. 25, 2020, the entire disclosure of which is herein incorporated by reference in its entirety.

### BACKGROUND OF THE DISCLOSURE

The present disclosure relates to the reduction of per/polyfluoroalkyl substances (PFAS), including perfluorooctanoic acid (PFOA), in irradiated or thermally degraded fluoropolymer micropowders. Fluoropolymer micropowders may be formed from higher molecular weight fluoropolymers through the process of irradiation, or ionization, of higher molecular weight fluoropolymers. The irradiation of high molecular weight fluoropolymers is known to result in the formation of short chain fluorocarbon species, including per- and poly-fluoroalkyl species (PFAS), including perfluorooctanoic acid (PFOA) and/or low molecular weight, water soluble fluoropolymers. Fluoropolymer micropowders may also be formed from the thermal degradation of higher molecular weight fluoropolymers, wherein such thermally degraded fluoropolymers may also include residual per- and poly-fluoroalkyl species (PFAS), including perfluorooctanoic acid (PFOA) and/or low molecular weight, water-soluble fluoropolymers.

The fluoropolymer regulatory landscape is evolving rapidly due to increasing concerns about PFAS, including PFOA, as a constituent of substances and/or mixtures.

What is needed is a method for efficient and effective production of fluoropolymer micropowders having a minimal amount of PFOA and PFAS.

### SUMMARY OF THE DISCLOSURE

The present disclosure relates to process, including a thermal treatment step, for the production of fluoropolymer micropowders having a reduced or minimized content of per/polyfluoroalkyl substances (PFAS) and/or perfluorooctanoic acid (PFOA).

In one form, the present disclosure provides a method for manufacturing a fluoropolymer micropowder, comprising thermally treating, at a temperature from 125° C. to 300° C. in a substantially oxygen free atmosphere, an irradiated or thermally degraded perfluorinated fluoropolymer.

In another form, the present disclosure provides a method for manufacturing a fluoropolymer micropowder, comprising thermally treating, at a temperature from 125° C. to 300° C. in a fluidized bed reactor, an irradiated or thermally degraded perfluorinated fluoropolymer.

In a still further form, the present disclosure provides a perfluorinated fluoropolymer micropowder, comprising: at least one of: a perfluorooctanoic acid (PFOA) content of less than 5 parts per billion (ppb), as determined by liquid chromatography-tandem mass spectrometry (LC-MS/MS); a total C₉-C₁₄ per/polyfluorocarboxylic acid content of less than 25 parts per billion (ppb), as determined by liquid chromatography-tandem mass spectrometry (LC-MS/MS); and a total C₄-C₁₈ per/polyfluorocarboxylic acid content of less than 25 parts per billion (ppb), as determined by liquid chromatography-tandem mass spectrometry (LC-MS/MS), and further, the fluoropolymer micropowder, when dispersed in a solvent-borne resin at a level of 15 wt. % solids, produces a Hegman gauge score of 7 or greater.

### BRIEF DESCRIPTION OF THE DRAWINGS

The above-mentioned and other features and advantages of this disclosure, and the manner of attaining them, will become more apparent and the disclosure itself will be better understood by reference to the following description of embodiments of the disclosure taken in conjunction with the accompanying drawings, wherein:

FIG. 1 is a schematic diagram showing a process for producing a low molecular weight fluoropolymer micropowder from a high molecular weight fluoropolymer.

FIG. 2A shows results of dispersibility testing, as described in Example 3.

FIG. 2B shows results of dispersibility testing, as described in Example 3.

FIG. 2C shows results of dispersibility testing, as described in Example 3.

### DETAILED DESCRIPTION

### 1. Definitions

For purposes of the following detailed description, it is to be understood that the invention may assume various alternative variations and step sequences, except where expressly specified to the contrary. Moreover, other than in any operating examples or where otherwise indicated, all numbers expressing, for example, quantities of ingredients used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The use of the singular includes the plural and plural encompasses singular, unless specifically stated otherwise. In addition, the use of “or” means “and/or” unless specifically stated otherwise, even though “and/or” may be explicitly used in certain instances.

### 2. Overview

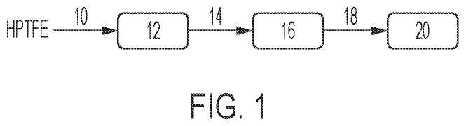

The present disclosure provides a method of manufacturing fluoropolymer micropowders, such as low molecular weight polytetrafluoroethylene (LPTFE) micropowders. As shown in FIG. 1, the method of the present disclosure may include a first step, in which a high molecular weight fluoropolymer is irradiated or thermally degraded at 10 to provide a low molecular weight fluoropolymer intermediate 12. In a second step 14, the low molecular weight fluoropolymer intermediate 12 is subjected to thermal treatment 14, which may additionally include agitation, to vaporize undesired perfluorooctanoic acid (PFOA) and per/polyfluoroalkyl (PFAS) species to provide a thermally treated intermediate low molecular weight fluoropolymer material 16. In a third step 18, the thermally treated low molecular weight fluoropolymer is micronized, or pulverized, at 18 to produce a low molecular weight fluoropolymer micropowder 20. Each step is discussed below in greater detail.

A low molecular weight fluoropolymer, such as low molecular weight polytetrafluoroethylene (LPTFE), may be produced by irradiating or thermally degrading a high molecular weight fluoropolymer, such as high molecular weight polytetrafluoroethylene (HPTFE), to reduce the molecular weight of the fluoropolymer. The low molecular weight fluoropolymer material may be further treated as discussed herein to produce solid micropowder products, which are desirable for use as additives in the production of coatings, plastics, elastomers, inks, lubricants, and cosmetics, among other products.

In the course of irradiation, per/polyfluoroalkyl species are produced, including perfluorooctanoic acid (PFOA) and/or various per/polyfluoroalkyl substances (PFAS), such as C₄-C₁₈ per/polyfluorocarboxylic acids, C₉-C₁₄ per/polyfluorocarboxylic acids and/or C₆ per/polyfluorocarboxylic acids. The foregoing substances may also be present in thermally degraded fluoropolymers. The present disclosure provides a method of manufacturing fluoropolymer micropowders, such as LPTFE micropowders, in which the content of these undesired by-products is reduced, minimized, or substantially eliminated.

Various physical properties may be used to describe fluoropolymers, such as number average molecular weight, density, melting point, and melt viscosity. Number average molecular weight (Mn) is defined as the average mass of macromolecules in a given polymer sample, as determined by dividing the sum of the molecular masses of individual macromolecules by the number of molecules present. The molecular mass may in turn be determined by methods such as gel permeation chromatography. Melting point may be determined by differential scanning calorimetry (DSC). Melt viscosity is a measurement of flow for a given melted material which may be determined by ASTM 1238. Bulk density may be determined by ASTM D5675 or ASTM D4895.

### 3. High Molecular Weight Fluoropolymer

The present process employs, as a starting material, also known as a base resin or feedstock, a high molecular weight fluoropolymer, such as high molecular weight polytetrafluoroethylene (HPTFE) or others set forth herein, and proceeds through a series of steps including irradiation, thermal treatment, and micronization, to arrive at a fluoropolymer micropowder, such as LPTFE micropowder, having low levels of PFOA and/or PFAS.

The fluoropolymer starting material may be in the form of a powder, and may be derived from a suspension polymerization process, thus categorized as granular powder. Alternatively, the powder may be generated from dispersion or emulsion (aqueous or non-aqueous) polymerization, thus known as coagulated dispersion fluoropolymer powder.

The fluoropolymer feedstock may have an average particle size of 20 microns or larger, 50 microns or larger 100 microns or larger, 150 microns or larger, 1000 microns or smaller, 750 microns or smaller, 500 microns or smaller, 300 microns or smaller, 250 microns or smaller, or within any range encompassing these endpoints.

The fluoropolymer may be a high molecular weight, perfluorinated fluoropolymer, including polytetrafluoroethylene (PTFE), fluorinated ethylene propylene (FEP), perfluoroalkoxy (PFA) and/or methylfluoroalkoxy (MFA). As used herein, the term perfluorinated fluoropolymer refers to a fully fluorinated fluoropolymer, in which all of the hydrogens of the hydrocarbon backbones (though not necessarily the end groups of the fluoropolymer) are substituted with fluorine atoms.

The PTFE may be modified PTFE, in which small amounts of modifying co-monomers are present. The modifying co-monomers may include perfluoropropylvinylether (PPVE), hexafluoropropylene (HFP), chlorotrifluoroethylene (CTFE), perfluorobutylethylene (PFBE), perfluoromethylvinylether (PMVE) and perfluoroethylvinylether (PEVE). The modifying co-monomer may be present in an amount of less than 1 wt. % based on the weight of the PTFE.

The PTFE, FEP, and/or PFA may also be scrap or recycled feedstock.

The first melting point of the PTFE, as determined by DSC, may be 345° C. or lower, 344° C. or lower, 343° C. or lower, 342° C. or lower, 341° C. or lower, 340° C. or lower, 339° C. or higher, 338° C. or higher, or 335° C. or higher, or within any range encompassing these endpoints.

The melting point of FEP of the type typically used as a feedstock for micropowders, as determined by DSC, may be from 255° C. to 275° C., such as 270° C.

The melting point of PFA of the type typically used as a feedstock for micropowders, as determined by DSC, may be from 280° C. to 220° C., such as 307° C.

The melting point of MFA, as determined by DSC, may be from 280° C. to 290° C.

### 4. Irradiation

Fluoropolymers, such as polytetrafluoroethylene (PTFE) and fluorinated ethylene propylene (FEP), for example, are susceptible to degradation by exposure to ionizing radiation. This susceptibility to radiation permits the breakage of carbon-carbon bonds via chain scission upon exposure to ionizing radiation. Once the carbon-carbon bonds break, lower molecular weight fluoropolymer species are formed.

Suitable sources of ionizing radiation include gamma rays, X-rays, ultraviolet rays, electron beams, and neutron beams. The ionizing radiation source may provide beta radiation.

The radiation dose may be as low as 2 Mrad or higher, 10 Mrad or higher, 50 Mrad or higher, 70 Mrad or higher, 90 Mrad or higher, 100 Mrad or lower, 150 Mrad or lower, 200 Mrad or lower, or within any range encompassing these endpoints.

The irradiation may be performed at a temperature of 5° C. or higher, 20° C. or higher, 50° C. or higher, 100° C. or higher, 150° C. or higher, 200° C. or lower, 250° C. or lower, 300° C. or lower, 320° C. or lower, or within any range encompassing these endpoints.

Although the irradiation may be performed under any atmosphere, such as air, inert atmosphere or vacuum, irradiation in the presence of oxygen may result in an undesirable generation of PFOA and/or carboxylic acid species. Therefore, in order to minimize the generation of PFOA and/or per/polyfluorocarboxylic acids such as C₄-C₁₈ per/polyfluorocarboxylic acids, C₉-C₁₄ per/polyfluorocarboxylic acids, and/or C₆ per/polyfluorocarboxylic acids, the material may be irradiated in an atmosphere substantially free of oxygen.

As used herein, the term substantially oxygen free atmosphere means that oxygen is present in an amount of 100 parts per million (ppm) or less, 50 ppm or less, 10 ppm or less, 5 ppm or less, 3 ppm or less, 2 ppm or less, or 1 ppm or less. In particular, the irradiation may be carried out under vacuum or in an inert atmosphere. An inert atmosphere may encompass a non-reactive gaseous atmosphere, such as a nitrogen or argon atmosphere, for example.

### 5. Thermal Degradation

In a process alternative to irradiation, fluoropolymers, such as polytetrafluoroethylene (PTFE) and fluorinated ethylene propylene (FEP), for example, may be exposed to thermal degradation, typically in a twin-screw extruder, to provide a low molecular weight fluoropolymer. Optionally, the fluoropolymer may be lightly irradiated prior to thermal degradation.

Low molecular weight fluoropolymer produced via these processes may have undesirable residual amounts of PFOA and/or per/polyfluorocarboxylic acids such as C₄-C₁₈ per/polyfluorocarboxylic acids, C₉-C₁₄ per/polyfluorocarboxylic acids, and/or C₆ per/polyfluorocarboxylic acids.

### 6. Low Molecular Weight Fluoropolymer

The low molecular weight fluoropolymer may be a perfluorinated fluoropolymer as described above, including polytetrafluoroethylene (PTFE), fluorinated ethylene propylene (FEP), perfluoroalkoxy (PFA) and/or methylfluoroalkoxy (MFA), having a reduced molecular weight as compared to the high molecular weight starting material. The low molecular weight fluoropolymer is produced by irradiation or thermal degradation of the high molecular weight fluoropolymer, and may be characterized by its, melting point, density, and melt viscosity for example.

The low molecular weight fluoropolymer may have a first melt temperature (Tm), as determined by a suitable method such as differential scanning calorimetry (DSC), that is either equal to or less than 332° C.

The first melt temperature of low molecular weight PTFE (LPTFE), as determined by DSC, may be 332° C. or lower, 330° C. or lower, 328° C. or lower, 326° C. or lower, 324° C. or lower, or 322° C. or lower, or within any range encompassing these endpoints.

The first melt temperature of low molecular weight FEP, as determined by DSC, may be 240° C.

Low molecular weight PTFE may have a melt viscosity as determined by ASTM 1238 of 1×10² Pa·s or greater, 1×10³ Pa·s or greater, 1×10⁴ Pa·s or greater, 1×10⁵ Pa·s or lower, 3×10⁵ Pa·s or lower, 5×10⁵ Pa·s or lower, 7×10⁵ Pa·s, or within any range encompassing these endpoints.

Measured melt viscosities may vary among fluoropolymer type depending on the isothermal holding time, wherein the measured melt viscosity may either increase or decrease with holding time. In one example, irradiated PEP had a melt viscosity that decreased with time, namely from 0.24 to 0.93 Pa·s in nitrogen and from 0.18 to 0.69 in air, each over time intervals from 3, 5, 10, 30 and 50 mins. In another example, irradiated PTFE had a melt viscosity that increased with time, namely from 0.19 to 0.34 Pa·s in nitrogen and from 0.16 to 0.31 in air, each over time intervals from 3, 5, 10, 30 and 50 mins.

### 7. Thermal Treatment

The low molecular weight fluoropolymer that has been irradiated or subjected to thermal degradation is subjected to one or more thermal, or heat, treatments. Irradiation of the high molecular weight fluoropolymer produces undesired PFAS species. During thermal treatment, these undesired PFAS species may be vaporized. Specifically, heat treatment may remove PFOA and/or per/polyfluorocarboxylic acids such as C₄-C₁₈ per/polyfluorocarboxylic acids, C₉-C₁₄ per/polyfluorocarboxylic acids, and/or C₆ per/polyfluorocarboxylic acids and their salts, while leaving longer chain (higher boiling) per- and poly-fluoroalkyl species intact.

The thermal treatment may be performed in a fluidized bed reactor. The fluidized bed reactor operates by a continuous and turbulent movement of a fluid within a reactor chamber, while the chamber is charged with a solid component. The fluid within the reactor may be an inert gas, with the fluoropolymer particles as the solid component. The inert gas is forced through a distributor, or porous plate, and through the environment that encompasses the fluoropolymer particles within the reactor's chamber. As the fluid velocity is increased, the reactor will reach a stage where the force of the inert gas on the fluoropolymer particles is enough to balance the weight of the fluoropolymer particles, and thus fluoropolymer particles are maintained in suspension. This stage is known as incipient fluidization and occurs at a minimum gas flow velocity. Once the minimum threshold velocity is surpassed, the contents of the reactor bed begin to expand and swirl around much like an agitated tank or boiling pot of water. At this stage the reactor now constitutes the “fluidized bed”. The fluoropolymer particles then behave kinetically as a fluid.

The reactor itself may be jacketed, or include other temperature-controlling elements, in combination with thermal control of inert gas, to enable temperature adjustment of the reactor and its charged contents. Once the desired fluidization phenomenon is achieved, each discrete particle of fluoropolymer is bathed in the inert gas for thermal extraction and related elimination of PFOA and/or PFAS species from the fluoropolymer particles. In particular, the fluoropolymer particles are each heated in their entirety, i.e., throughout their cross section, in order to more fully vaporize undesired PFOA and/or PFAS species. The method of the present disclosure allows for uniform and consistent heating of the fluoropolymer particles such that undesired PFOA and/or PFAS may be vaporized from, or thermally extracted from, the fluoropolymer particles. In this manner, the undesirable PFAS species are essentially “boiled off” through this process of calcination within the fluidized bed reactor, while the integrity and desired chemistry of the resulting fluoropolymer particles is preserved.

The low molecular weight fluoropolymer may be heated to a temperature of 125° C., or up to a temperature below the melting point of the LPTFE or other low molecular weight fluoropolymer, for example up to 300° C. In other words, the temperature may approach the melting point of the material but not be high enough to cause the material to melt. Suitable temperatures may be 125° C. or greater, 150° C. or greater, 175° C. or greater, 200° C. or greater, 332° C. or lower, 315° C. or lower, 300° C. or lower, 275° C. or lower, or within any range encompassing these endpoints.

Without being bound by theory, the thermal treatment step may promote selective pyrolysis of the LPTFE or other low molecular weight fluoropolymer intermediate powder. Specifically, the decomposition brought about by high temperature, herein referred to as selective pyrolysis, may vaporize the undesired PFAS species, including PFOA, while leaving the comparatively larger molecular weight fluoropolymer chains of the polymer intact.

The thermal treatment may be performed in the presence or absence of oxygen. However, thermal treatment in the absence of oxygen may mitigate or prevent the formation of carboxylic acid end groups during the thermal treatment. Thus, the thermal treatment is advantageously performed in a substantially oxygen-free, or anaerobic, atmosphere. As used herein, substantially oxygen free atmosphere means that oxygen is present in an amount of 100 parts per million (ppm) or less, 50 ppm or less, 10 ppm or less, 5 ppm or less, 3 ppm or less, 2 ppm or less, or 1 ppm or less.

In particular, the thermal treatment may be carried out under vacuum, in an inert atmosphere, or in a reducing or anaerobic atmosphere. An inert atmosphere may encompass a non-reactive gaseous atmosphere, such as a nitrogen or argon atmosphere, for example.

### 8. Micronization

Following thermal treatment, the LPTFE or other low molecular weight fluoropolymer may be micronized, or pulverized, to reduce the particle size of the fluoropolymer particles and produce a micropowder. Suitable micronizers include impact micronizers and grinding micronizers. Examples of suitable impact micronizers may include hammer mills, pin mills, and jet mills. Examples of suitable grinding micronizers may include cutter mills.

A jet mill may be used to form the micropowder. Jet mills use high speed jets comprising compressed air or inert gas to impact particles together. Particles of a certain size or smaller may comprise the output of the mill, while larger particles continue to be milled. Thus, jet milling may be used to produce a narrow size distribution of milled particles.

Following micronization, the average size of the micropowder particles may be 1.0 micron or larger, 3.0 microns or larger, 7.5 microns or smaller, 10.0 microns or smaller, or 15.0 microns or smaller, or within any range encompassing these endpoints. The particle size may be determined by the methods described in ASTM D5675-13, for example.

### 9. Low Molecular Weight Fluoropolymer Micropowder

The low molecular weight fluoropolymer micropowder, such as low molecular weight polytetrafluoroethylene (LPTFE), may have a specific surface area as low as 2 m²/g, 4 m²/g, or 6 m²/g, or as large as 12 m²/g, 14 m²/g, or 16 m²/g, or within any range encompassing these endpoints, as determined using a surface analyser.

The micropowders may have a bulk density, determined in accordance with ASTM D5675 (which references ASTM D4895) of from 250 g/L to 650 g/L.

The amount of per- and poly-fluoroalkyl species may be determined by liquid chromatography-tandem mass spectrometry (LC-MS/MS), which may be practiced using isotope dilution. The dry limit of quantification (LOQ) may be less than 1.0 parts per billion (ppb).

The total amount of perfluorooctanoic acid (PFOA) present in the micropowder may be 25 parts per billion (ppb) or less, 20 ppb or less, 15 ppb or less, 10 ppb or less, or 5 ppb or less.

The total amount of C₄-C₁₈ per/polyfluorocarboxylic acids present in the micropowder may be 25 parts per billion (ppb) or less, 20 ppb or less, 15 ppb or less, 10 ppb or less, or 5 ppb or less.

The total amount of C₉-C₁₄ per/polyfluorocarboxylic acids present in the micropowder may be 25 parts per billion (ppb) or less, 20 ppb or less, 15 ppb or less, 10 ppb or less, or 5 ppb or less.

The total amount of C₆ per/polyfluorocarboxylic acids present in the micropowder may be 25 parts per billion (ppb) or less, 20 ppb or less, 15 ppb or less, 10 ppb or less, or 5 ppb or less.

Additionally, the total combined amount of perfluorooctanoic acid (PFOA), C₄-C₁₈ per/polyfluorocarboxylic acids, C₉-C₁₄ per/polyfluorocarboxylic acids, and C₆ per/polyfluorocarboxylic acids present in the micropowder may be 25 parts per billion (ppb) or less, 20 ppb or less, 15 ppb or less, 10 ppb or less, or 5 ppb or less.

The micropowder particles may be highly dispersible in a fluid system, such as an aqueous system or a solvent-borne system. Dispersibility may be evaluated by using a blade test, such as a Hegman gauge. The Hegman gauge is a finely machined block of steel with a ramp. The ramp begins at a score of 0, which corresponds to a depth of 101.6 um (4.0 mils) from the surface, and steadily rises to a flush finish at a score of 8. Each score corresponds to a 12.7 um (0.5 mil) change in depth on the gauge.

During the test, a dispersion of the micropowder is added to the ramp at point A flat machined blade paired with the gauge is dragged across the top of the side walls of the ramp to create a gap between the floor of the ramp and the blade edge. The dispersion is forced through the gap, which grows smaller as the blade is moved up the ramp. Eventually, undistributed particles in the dispersion are too large to fit through the gap and are dragged along by the blade, thereby creating drag marks that are visible to the naked eye. The beginning of the drag marks denotes the largest particle size in the system according to the gauge reading. A sample is then assigned a Hegman score from 0 (least dispersible) to 8 (most dispersible). A score of greater than 8 suggests that the particle size was small enough to pass through even the smallest gap on the gauge, i.e., a particle size of less than 12.7 um (less than 0.5 mil).

The micropowders of the present disclosure display a Hegman score of 5 or higher, such as 6 or higher, 7 or higher, or 8 or higher when dispersed in a solvent, according to ASTM D1210-05(2014)—Fineness of Dispersion by Hegman Grind Gauge.

The fluoropolymer micropowder may be used in various applications, such as coatings, additives in the production of plastics, elastomers, inks, lubricants, and cosmetics, among other products.

### EXAMPLES

### Example 1: Manufacture of LPTFE Micropowder

### Irradiation

An HPTFE homopolymer in nascent form, manufactured by means of granular polymerization, was used as the starting material. The granular HPTFE feedstock powder had not been previously melted and was therefore considered virgin material. The powder demonstrated an average particle size of approximately 200 microns with a melting point of 342° C.

The HPTFE was subjected to Beta-type ionizing radiation under an air atmosphere at gross irradiating dosage of 90 Megarad to produce an irradiated LPTFE intermediate. It was determined that through the process of ionizing the base resin PTFE in air, perfluoroalkyl substances (PFAS) were produced, including perfluorooctanoic acid (PFOA) at concentrations above 25 ppb.

### Thermal Treatment

A 900 kg sample of the LPTFE intermediate was subjected to a thermal treatment in a fluidized bed reactor. The reactor vessel included an integral heating jacket, through which hot thermal fluid was circulated. The reactor was fitted with a sample collection system, to allow for withdrawal of solids material from the reactor during or after processing. A gas train was assembled to supply the desired fluidizing gases to the inlet plenum of the reactor vessel. The fluidizing gas used was nitrogen from a cryogenic nitrogen facility. The fluidizing gas was pre-heated in an electric preheater.

Off-gasses/effluents were exhausted through an internal high-temperature filter system, for particulate removal from the exhaust gas. Material was loaded into the reactor vessel via vacuum loading. The heat treated LPTFE intermediate material was discharged by gravity through a nozzle at the bottom of the vessel.

The thermal treatment was performed using an inert (nitrogen) fluidizing gas stream, targeting a solids bed temperature of 290° C., and a hold time at this temperature of 1.5 hours. The general procedure was to load a specified quantity of the intermediate into the reactor, fluidize the solids bed with nitrogen and achieve desired and steady flow rate, and heat and hold the material in a prescribed manner to an ultimate temperature, observing specific heating ramp rates and hold times at intermediate temperatures, as may be prescribed. Thus, each discreet intermediate particle was bathed in a nitrogen atmosphere and continuously agitated and circulated to optimize selective pyrolysis and/or “boiling off” of undesired PFAS species. Gas flow was adjusted during the process if desired, to prevent settling due to gravitational forces and achieve desired and consistent fluidization of intermediate powder. Samples were withdrawn from the reactor at various times during the process for evaluation. After the execution of the prescribed run profile, the reactor and solids bed were cooled down to near-ambient temperature, and the resultant thermally treated LPTFE intermediate material was discharged from the reactor.

### Micronization

The thermally treated LPTFE intermediate was reduced in particle size via jet milling through the process of micronization. Jet milling was performed in ambient conditions, and thus a prevailing aerobic atmosphere. After jet milling step, the resulting powder was categorized as a micropowder, with the utility, characteristics, and properties of a fluoropolymer additive. The average particle size of the micronized powder was 3.5 microns on average. Tolerance around the mean was +0.75 microns.

### Chemical Analysis

To ensure that PFAS species were not hidden or embedded in the inner matrix of the intermediate particles and thus subject to partition coefficients and thermal gradients which might yield inaccurate information related to PFAS content within the matrix of the micropowder, an analysis of PFAS species was subsequently performed on the downstream micropowder in addition to the thermally treated LPTFE intermediate.

From the 900 kg sample powder lot, two 50-gram samples were extracted from the trial batch. The first sample was randomly extracted from the first 500 kgs, and the second selected randomly from second 400 kgs. This allowed for duplication of testing and comparison of the results to confirm measurement consistency and achieve an overall higher confidence level in the results.

PFAS measurement was determined by liquid chromatography-tandem mass spectrometry (LC-MS/MS).

The results of these measurements are shown below, beginning with Table 1 which shows perfluorooctanoic acid content in the micropowder, with and without thermal treatment, as well as the intermediate. All measurements are given in ppb.

TABLE 1

| | # | Micropowder | | | |
|---|---|---|---|---|---|
| | Carbon | w/o thermal | | Micropowder | Micropowder |
| PFAS Species | atoms | treatment | Intermediate | Sample 1 | Sample 2 |
| Perfluorooctanoic | 8 | 900 | 3.1 | 2.6 | 3.5 |
| acid | | | | | |

Table 2, below, shows perfluorohexanoic acid (C₆) content. Analysis was conducted to determine perfluorohexanoic content in the micropowder, with and without heat treatment, as well as the intermediate. All measurements are given in ppb.

TABLE 2

| | # | Micropowder | | | |
|---|---|---|---|---|---|
| | Carbon | w/o thermal | | Micropowder | Micropowder |
| PFAS Species | atoms | treatment | Intermediate | Sample 1 | Sample 2 |
| Perfluorohexanoic | 6 | 720 | 3.4 | 3.8 | 4.7 |
| acid | | | | | |

Finally, analysis was conducted to determine the content of a number of longer chain (C₉-C₁₄) PFAS species. The results are shown below in Table 3, below. Analysis was conducted to determine C₉-C₁₄ PFAS content in the micropowder, with and without heat treatment, as well as the intermediate. All measurements are given in ppb.

TABLE 3

| | # | Micropowder | | | |
|---|---|---|---|---|---|
| | Carbon | w/o thermal | | Micropowder | Micropowder |
| PFAS Species | atoms | treatment | Intermediate | Sample 1 | Sample 2 |
| Perfluorononanoic | 9 | 1000 | 3.6 | 2.5 | 3.5 |
| acid | | | | | |
| Perfluorodecanoic | 10 | 890 | 3.9 | 2.5 | 3.2 |
| acid | | | | | |
| Perfluoroundecanoic | 11 | 860 | 4.2 | 2.1 | 2.9 |
| acid | | | | | |
| Perfluorododecanoic | 12 | 880 | 4.8 | 2.3 | 2.7 |
| acid | | | | | |
| Perfluorotridecanoic | 13 | 970 | 3.8 | 1.7 | 2.0 |
| acid | | | | | |
| Perfluorotetradecanoic | 14 | 960 | 5.6 | 3.0 | 3.2 |
| acid | | | | | |

| | | | | |
|---|---|---|---|---|
| TOTAL | 5560 | 25.9 | 14.1 | 17.5 |

### Example 2: Further Preparation and Evaluation of LPTFE Intermediate

### Irradiation

In this Example, a relatively large amount (2500 kg) of LPTFE intermediate was prepared and evaluated. A HPTFE homopolymer in nascent form, manufactured by means of granular polymerization, was used as the starting material. The granular HPTFE feedstock powder had not been previously melted and was therefore considered virgin material. The powder demonstrated an average particle size of approximately 200 microns with a melting point of 342° C.

As with Example 1, the HPTFE was subjected to Beta-type ionizing radiation under an air atmosphere at gross irradiating dosage of 90 Megarad to produce an irradiated LPTFE intermediate including perfluorooctanoic acid (PFOA) at concentrations above 25 ppb.

### Thermal Treatment

The 2500 kg of the LPTFE intermediate was subjected to a thermal treatment in a fluidized bed reactor, with identical processing parameters as in Example 1. The reactor vessel included an integral heating jacket, through which hot thermal fluid was circulated. The reactor was fitted with a sample collection system, to allow for withdrawal of solids material from the reactor during or after processing. A gas train was assembled to supply the desired fluidizing gases to the inlet plenum of the reactor vessel. The fluidizing gas used was nitrogen from a cryogenic nitrogen facility. The fluidizing gas was pre-heated in an electric preheater.

Off-gasses/effluents were exhausted through an internal high-temperature filter system, for particulate removal from the exhaust gas. Material was loaded into the reactor vessel via vacuum loading. The heat treated LPTFE, intermediate material was discharged by gravity through a nozzle at the bottom of the vessel.

The thermal treatment was performed using an inert (nitrogen) fluidizing gas stream, targeting a solids bed temperature of 290° C., and a zero-minute hold time at this temperature. Once the maximum and target temperature of 290° C. was reached, cool down commenced. The general procedure was to load a specified quantity of the intermediate into the reactor, fluidize the solids bed with nitrogen and achieve desired and steady flow rate, and heat and hold the material in a prescribed manner to an ultimate temperature, observing specific heating ramp rates and hold times at intermediate temperatures, as may be prescribed. Thus, each discreet intermediate particle was bathed in a nitrogen atmosphere and continuously agitated and circulated to optimize selective pyrolysis and/or “boiling off” of undesired PFAS species. as flow was adjusted during the process if desired, to prevent settling due to gravitational forces and achieve desired and consistent fluidization of intermediate powder. Samples were withdrawn from the reactor at various time during the process for evaluation. After the execution of the prescribed run profile, the reactor and solids bed were cooled down to near-ambient temperature, and the resultant thermally treated LPTFE intermediate material was discharged from the reactor.

### Chemical Analysis

An analysis of PFAS species was subsequently performed on the thermally treated LPTFE intermediate derived from this bulk production campaign.

From the 2500 kg sample powder lot, a total of ten 10-gram samples were extracted from the trial batch. All aliquots were randomly extracted from random drums by 2 different operators to promote random sampling techniques. Each operator pulled five 10-gram samples from random drums, at random depths of the material within the drums, comprising the 2500 kgs bulk campaign. This allowed for duplication of testing and comparison of the results to confirm measurement consistency and achieve an overall higher confidence level in the results. Each operator combined the five 10-gram samples into a small glass laboratory vial jar and mixed vigorously. Two discreet 50 kg sample jars resulted (Intermediate Sample 1 and Intermediate Sample 2 in the tables below) and were subsequently provided to the third-party laboratory for full PFAS analysis in the same manner as Example 1.

PFAS measurement was determined by liquid chromatography-tandem mass spectrometry (LC-MS/MS).

The results of these measurements are shown below, beginning with Table 4 which shows perfluorooctanoic acid content in the intermediate generated from the scale-up manufacturing campaign. All measurements are given in ppb.

TABLE 4

| | # Carbon | Intermediate | Intermediate |
|---|---|---|---|
| PFAS Species | atoms | Sample 1 | Sample 2 |
| Perfluorooctanoic | 8 | 6.2 | 7.4 |
| acid | | | |

Table 5, below, shows perfluorohexanoic acid (C₆) content. Analysis was conducted to determine perfluorohexanoic content in the intermediate. All measurements are given in ppb.

TABLE 5

| | # Carbon | Intermediate | Intermediate |
|---|---|---|---|
| PFAS Species | atoms | Sample 1 | Sample 2 |
| Perfluorohexanoic | 6 | 9.5 | 10 |
| acid | | | |

Finally, analysis was conducted to determine the content of a number of longer chain (C₉-C₁₄) PFAS species. The results are shown below in Table 6, below. All measurements are given in ppb.

TABLE 6

| | # Carbon | Intermediate | Intermediate |
|---|---|---|---|
| PFAS Species | atoms | Sample 1 | Sample 2 |
| Perfluorononanoic | 9 | 5.8 | 7.6 |
| acid | | | |
| Perfluorodecanoic | 10 | 3.7 | 6.7 |
| acid | | | |
| Perfluoroundecanoic | 11 | 3.5 | 9.9 |
| acid | | | |
| Perfluorododecanoic | 12 | 3.2 | 9.6 |
| acid | | | |
| Perfluorotridecanoic | 13 | 2.4 | 10 |
| acid | | | |
| Perfluorotetradecanoic | 14 | 3.1 | 14 |
| acid | | | |

| | | |
|---|---|---|
| TOTAL | 21.7 | 57.8 |

### Example 3: Dispersibility Test

Three micropowder formulations were tested for dispersibility in a solvent-borne resin. The micropowder compositions and methods of preparation are shown below in Table 7.

The three micropowders were prepared from high molecular weight, virgin granular PTFE which was irradiated via beta irradiation, also known as e-beam treatment, in ambient and thus aerobic conditions. This irradiated PTFE was used to prepare each of Comparative Examples A and B and Formulation 1 below.

Comparative Example A was prepared by irradiation of the aforementioned PTFE feedstock at a dosage of 90 Megarads. This was followed by thermal treatment in an oven with air circulation at 400° F. (204° C.) for 4.5 hours. The intermediate was then micronized to an average particle size of 3.5 microns.

Comparative Example B was prepared by irradiation of the aforementioned PTFE feedstock at a dosage of 90 Megarads. This was followed by thermal treatment in an oven with air circulation at 400° F. (204° C.) for 4.5 hours. The intermediate was then micronized to an average particle size of 3.5 microns. The resulting micropowder was then subjected to the calcination thermal treatment in inert atmosphere and fluidized bed as described above in Example 1.

Formulation 1, prepared in accordance with the present disclosure, was that of Example 1 above, having minimal amounts of PFOA/PFAS.

The foregoing is summarized in Table 7 below.

TABLE 7

| Formulation | Composition | Summary of Preparation Method |
|---|---|---|
| Comparative | PTFE | 1) Irradiation; 2) Micronization |
| Example A | | |
| Comparative | PTFE | 1) Irradiation; 2) Micronization; |
| Example B | | 3) Thermal Treatment |
| Formulation 1 | PTFE | 1) Irradiation; 2) Thermal Treatment; |
| | | 3) Micronization |

To form a resin solution for testing, polyether sulfone at 24.3 wt. % was dissolved in an N-methyl-pyrrolidone solvent blend at 75.7 wt. % (NMP, GBL, Aromatic 150). To form each test solution, an amount of the solvent blend was weighed out (54-58 g) into a cup, then a 15 wt. % of the selected micropowder (9-10.5 g) was mixed into the resin solution to achieve a mixture of 15 wt. % solids micropowder in 85 wt. % resin solution. The total sample weight was between 64 g and 68 g in each case. A paddle blade air mixer at low speed was used to wet the micropowder and incorporate it prior to applying high-shear forces. The mixing process lasted for approximately 15 seconds prior to beginning high-shear mixing. High-shear mixing was performed using an electric mixer equipped with a 1.75″ diameter Cowles blade spinning at 4700-5000 rpm for 4 minutes.

Once the test dispersions were formulated, each was added to a Hegman gauge, and the results were observed and scored for three separate test runs according to ASTM D1210-05. The scores are shown below in Table 8.

TABLE 8

| | Test 1 | Test 2 | Test 3 |
|---|---|---|---|
| Comparative | 0 | 0 | 0 |
| Example A | | | |
| Comparative | 0 | 0 | 0 |
| Example B | | | |
| Formulation 1 | 8+ | 8+ | 8+ |

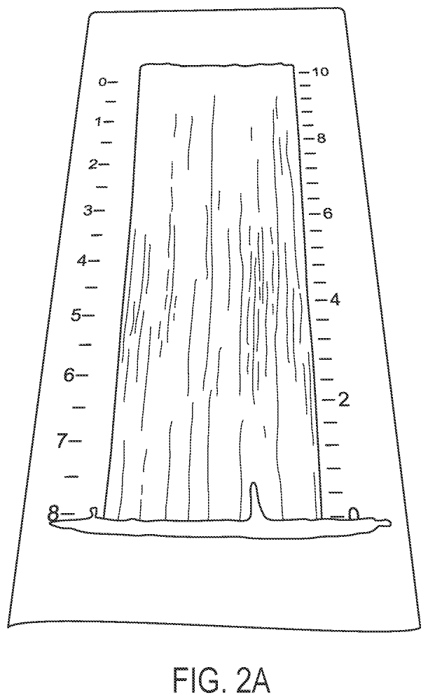

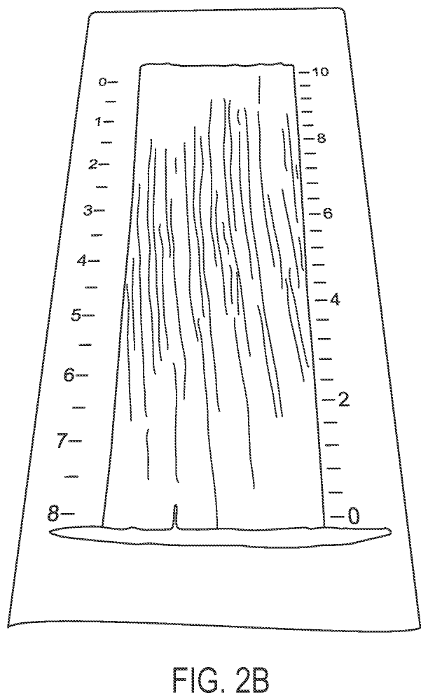

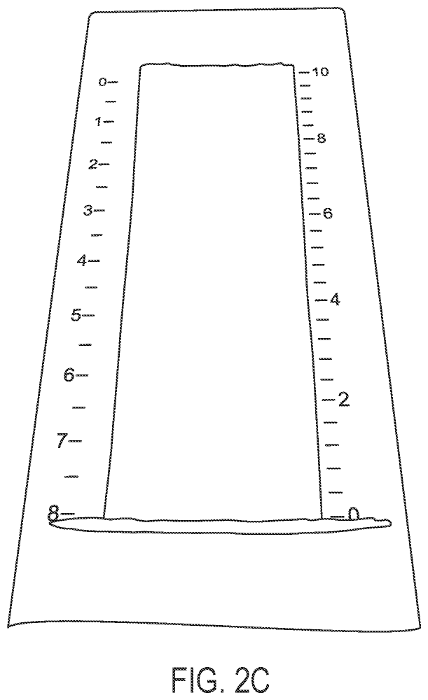

As described above, a score of 0 indicates the lowest dispersibility, while a score of 8 or greater indicates the highest. As can be seen in FIG. 2A, the formulation comprising Comparative Example A displays drag marks along the entirety of the testing surface and multiple large particulates at the 0/1 line, showing poor dispersibility. As shown in FIG. 2B, the formulation comprising Comparative Example B also displays drag marks along the entirety of the testing surface and multiple large particulates at the 0/1 line, again showing poor dispersibility. As shown in FIG. 2C, Formulation 1, comprising the micropowder of the present disclosure, displays no drag marks or large particulates, showing excellent dispersability.

### Aspects

Aspect 1 is a method for manufacturing a fluoropolymer micropowder, comprising thermally treating, at a temperature from 125° C. to 300° C. in a substantially oxygen free atmosphere, an irradiated or thermally degraded perfluorinated fluoropolymer.

Aspect 2 is the method of Aspect 1, wherein the perfluorinated fluoropolymer is selected from polytetraflouroethylene (PTFE), fluorinated ethylene propylene (FEP), perfluoroalkoxy (PFA), methylfluoroalkoxy (MFA) and combinations of the foregoing.

Aspect 3 is the method of claim 2, wherein the perfluorinated fluoropolymer comprises polytetraflouroethylene (PTFE) having a first melt temperature of 345° C. or lower, as determined by differential scanning calorimetry (DSC).

Aspect 4 is the method of any of Aspects 1-3, wherein the perfluorinated fluoropolymer is an irradiated perfluorinated fluoropolymer.

Aspect 5 is the method of any of Aspects 1-4, wherein the thermal treating step further comprises heating the perfluorinated fluoropolymer in a fluidized bed reactor.

Aspect 6 is the method of any of Aspects 1-5, wherein the substantially oxygen free atmosphere includes less than 50 parts per million (ppm) oxygen.

Aspect 7 is the method of any of Aspects 1-6, wherein the thermally treated perfluorinated fluoropolymer has a perfluorooctanoic acid (PFOA) content of less than 25 parts per billion (ppb), as determined by liquid chromatography-tandem mass spectrometry (LC-MS/MS).

Aspect 8 is the method of any of Aspects 1-7, wherein the thermally treated perfluorinated fluoropolymer has a total C₉-C₁₄ per/polyfluorocarboxylic acid content of less than 25 parts per billion (ppb), as determined by liquid chromatography-tandem mass spectrometry (LC-MS/MS).

Aspect 9 is the method of any of Aspects 1-8, wherein the thermally treated perfluorinated fluoropolymer has a total C₄-C₁₈ per/polyfluorocarboxylic acid content of less than 25 parts per billion (ppb), as determined by liquid chromatography-tandem mass spectrometry (LC-MS/MS).

Aspect 10 is the method of any of Aspects 1-9, further comprising micronizing the thermally treated fluoropolymer to form a fluoropolymer micropowder.

Aspect 11 is a method for manufacturing a fluoropolymer micropowder, comprising thermally treating, at a temperature from 125° C. to 300° C. in a fluidized bed reactor, an irradiated or thermally degraded perfluorinated fluoropolymer.

Aspect 12 is the method of Aspect 11, wherein the perfluorinated fluoropolymer is selected from polytetraflouroethylene (PTFE), fluorinated ethylene propylene (FEP), perfluoroalkoxy (PFA), methylfluoroalkoxy (MFA) and combinations of the foregoing.

Aspect 13 is the method of Aspect 12, wherein the perfluorinated fluoropolymer comprises polytetraflouroethylene (PTFE) having a first melt temperature of 345° C. or lower, as determined by differential scanning calorimetry (DSC).

Aspect 14 is the method of any of Aspects 11-13, wherein the perfluorinated fluoropolymer is an irradiated perfluorinated fluoropolymer.

Aspect 15 is the method of any of Aspects 11-14, wherein the thermal treating step further comprises heating the fluoropolymer in a substantially oxygen free atmosphere.

Aspect 16 is the method of Aspect 15, wherein the substantially oxygen free atmosphere includes less than 50 ppm parts per million (ppm) oxygen.

Aspect 17 is the method of any of Aspects 11-16, wherein the thermally treated perfluorinated fluoropolymer has a perfluorooctanoic acid (PFOA) content of less than 5 parts per billion (ppb), as determined by liquid chromatography-tandem mass spectrometry (LC-MS/MS).

Aspect 18 is the method of any of Aspects 11-17, wherein the thermally treated perfluorinated fluoropolymer has a total C₉-C₁₄ per/polyfluorocarboxylic acid content of less than 25 parts per billion (ppb), as determined by liquid chromatography-tandem mass spectrometry (LC-MS/MS).

Aspect 19 is the method of any of Aspects 11-18, wherein the thermally treated perfluorinated fluoropolymer has a total C₄-C₁₈ per/polyfluorocarboxylic acid content of less than 25 parts per billion (ppb), as determined by liquid chromatography-tandem mass spectrometry (LC-MS/MS).

Aspect 20 is the method of any of Aspects 11-19, further comprising micronizing the thermally treated fluoropolymer to form a fluoropolymer micropowder.

Aspect 21 is a perfluorinated fluoropolymer micropowder manufactured by any of the methods of Aspects 1-10 or 11-20.

Aspect 22 is a perfluorinated fluoropolymer micropowder, comprising at least one of: a perfluorooctanoic acid (PFOA) content of less than 5 parts per billion (ppb), as determined by liquid chromatography-tandem mass spectrometry (LC-MS/MS); a total C₉-C₁₄ per/polyfluorocarboxylic acid content of less than 25 parts per billion (ppb), as determined by liquid chromatography-tandem mass spectrometry (LC-MS/MS); and a total C₄-C₁₈ per/polyfluorocarboxylic acid content of less than 25 parts per billion (ppb), as determined by liquid chromatography-tandem mass spectrometry (LC-MS/MS), and further, the fluoropolymer micropowder, when dispersed in a solvent-borne resin at a level of 15 wt. % solids, produces a Hegman gauge score of 7 or greater according to ASTM D1210-05.

Aspect 23 is the perfluorinated fluoropolymer micropowder of Aspect 22, wherein the perfluorinated fluoropolymer micropowder is selected from polytetraflouroethylene (PTFE), fluorinated ethylene propylene (FEP), perfluoroalkoxy (PFA), methylfluoroalkoxy (MFA) and combinations of the foregoing.

While this disclosure has been described as having exemplary designs, the present disclosure may be further modified with the spirit and scope of this disclosure. Further, this application is intended to cover such departures from the present disclosure as come within known or customary practice in the art to which this disclosure pertains.

What is claimed is:

1. A method for manufacturing a fluoropolymer micropowder, comprising thermally treating, at a temperature from 125° C. to 300° C. in a substantially oxygen free atmosphere, an irradiated or thermally degraded perfluorinated fluoropolymer.

2. The method of claim 1, wherein the perfluorinated fluoropolymer is selected from polytetraflouroethylene (PTFE), fluorinated ethylene propylene (FEP), perfluoroalkoxy (PFA), methylfluoroalkoxy (MFA) and combinations of the foregoing.

3. The method of claim 2, wherein the perfluorinated fluoropolymer comprises polytetraflouroethylene (PTFE) having a first melt temperature of 345° C. or lower, as determined by differential scanning calorimetry (DSC).

4. The method of claim 1, wherein the perfluorinated fluoropolymer is an irradiated perfluorinated fluoropolymer.

5. The method of claim 1, wherein the thermal treating step further comprises heating the perfluorinated fluoropolymer in a fluidized bed reactor.

6. The method of claim 1, wherein the substantially oxygen free atmosphere includes less than 50 parts per million (ppm) oxygen.

7. The method of claim 1, wherein the thermally treated perfluorinated fluoropolymer has a perfluorooctanoic acid (PFOA) content of less than 25 parts per billion (ppb), as determined by liquid chromatography-tandem mass spectrometry (LC-MS/MS).

8. The method of claim 1, wherein the thermally treated perfluorinated fluoropolymer has a total C₉-C₁₄ per/polyfluorocarboxylic acid content of less than 25 parts per billion (ppb), as determined by liquid chromatography-tandem mass spectrometry (LC-MS/MS).

9. The method of claim 1, wherein the thermally treated perfluorinated fluoropolymer has a total C₄-C₁₈ per/polyfluorocarboxylic acid content of less than 25 parts per billion (ppb), as determined by liquid chromatography-tandem mass spectrometry (LC-MS/MS).

10. The method of claim 1, further comprising micronizing the thermally treated fluoropolymer to form a fluoropolymer micropowder.

11. A method for manufacturing a fluoropolymer micropowder, comprising thermally treating, at a temperature from 125° C. to 300° C. in a fluidized bed reactor, an irradiated or thermally degraded perfluorinated fluoropolymer.

12. The method of claim 11, wherein the perfluorinated fluoropolymer is selected from polytetraflouroethylene (PTFE), fluorinated ethylene propylene (FEP), perfluoroalkoxy (PFA), methylfluoroalkoxy (MFA) and combinations of the foregoing.

13. The method of claim 12, wherein the perfluorinated fluoropolymer comprises polytetraflouroethylene (PTFE) having a first melt temperature of 345° C. or lower, as determined by differential scanning calorimetry (DSC).

14. The method of claim 11, wherein the perfluorinated fluoropolymer is an irradiated perfluorinated fluoropolymer.

15. The method of claim 11, wherein the thermal treating step further comprises heating the fluoropolymer in a substantially oxygen free atmosphere.

16. The method of claim 15, wherein the substantially oxygen free atmosphere includes less than 50 ppm parts per million (ppm) oxygen.

17. The method of claim 11, wherein the thermally treated perfluorinated fluoropolymer has a perfluorooctanoic acid (PFOA) content of less than 5 parts per billion (ppb), as determined by liquid chromatography-tandem mass spectrometry (LC-MS/MS).

18. The method of claim 11, wherein the thermally treated perfluorinated fluoropolymer has a total C₉-C₁₄ per/polyfluorocarboxylic acid content of less than 25 parts per billion (ppb), as determined by liquid chromatography-tandem mass spectrometry (LC-MS/MS).

19. The method claim 11, wherein the thermally treated perfluorinated fluoropolymer has a total C₄-C₁₈ per/polyfluorocarboxylic acid content of less than 25 parts per billion (ppb), as determined by liquid chromatography-tandem mass spectrometry (LC-MS/MS).

20. The method of claim 11, further comprising micronizing the thermally treated fluoropolymer to form a fluoropolymer micropowder.

21. A perfluorinated fluoropolymer micropowder, comprising:
at least one of:
a perfluorooctanoic acid (PFOA) content of less than 5 parts per billion (ppb), as determined by liquid chromatography-tandem mass spectrometry (LC-MS/MS);
a total C₉-C₁₄ per/polyfluorocarboxylic acid content of less than 25 parts per billion (ppb), as determined by liquid chromatography-tandem mass spectrometry (LC-MS/MS); and
a total C₄-C₁₈ per/polyfluorocarboxylic acid content of less than 25 parts per billion (ppb), as determined by liquid chromatography-tandem mass spectrometry (LC-MS/MS), and further,
the fluoropolymer micropowder, when dispersed in a solvent-borne resin at a level of 15 wt. % solids, produces a Hegman gauge score of 7 or greater according to ASTM D1210-05.

22. The perfluorinated fluoropolymer micropowder of claim 21, wherein the perfluorinated fluoropolymer micropowder is selected from polytetraflouroethylene (PTFE), fluorinated ethylene propylene (FEP), perfluoroalkoxy (PFA), methylfluoroalkoxy (MFA) and combinations of the foregoing.
